(19) United States
(12) Patent Application Publication
(10) Pub. No.: US 2008/0160243 A1
(43) Pub. Date: Jul. 3, 2008

(54) Film Element And Method For Its Production

(75) Inventor: Ulrich Moosheimer, Hohenkammern (DE)

Correspondence Address: COLLARD & ROE, P.C., 1077 NORTHERN BOULEVARD, ROSLYN, NY, 11576, US

(73) Assignee: Schreiner Group GmbH & Co.KG

(21) Appl. No.: 11/795,775

(22) PCT Filed: Dec. 23, 2005
(86) PCT No.: PCT/EP2005/057143

§ 371 Date: Jul. 20, 2007

(30) Foreign Application Priority Data
Feb. 1, 2005 (EP) 05100662.5

(51) Int. Cl. B32B 3/10; G09F 3/02; B32B 38/04; B05D 7/24; B32B 38/14; G09F 3/10

(52) U.S. Cl. 428/43; 427/289

(57) ABSTRACT

According to the invention, a separation line (3) is spanned by a mass applied by printing, spraying, moulding or other means, forming a spanning layer (6) after fixing by a drying and/or cross-linking and/or other physical and/or chemical process, which limits the relative movement of parts adjacent to the separation line (3). A film element comprising only one film layer (1) can be simply and economically modified such as to be significantly easier to dispense, in particular on automatic or semiautomatic dispensing machines. The spanning layer (6) can combine other properties other than the spanning of the separation line, for example, increasing the stability and/or improving the handling properties of a part of the film element. Planar overprinted suspension loops (2) of such adhesive labels can hence be better gripped as a result of the reinforcing effect of the overprinting.

The present invention relates to a film element, particularly a film element having a parting line, as well as to a method for its production.

Punched, slit, or parting lines produced in another way usually serve to divide a film element into two or more functional regions.

So-called hanger labels, which serve to hang up containers, particularly in the sector of medicine, but also in the field of drugstore goods and, in most cases, to characterize their contents at the same time, are described many times in the state of the art. These are film elements configured as self-adhesive labels, which have a stirrup-shaped hang tab, divided from the remaining part of the label by way of a parting line. The hang tab can be pulled out of the remainder of the label, glued onto the container, for example an infusion bottle, and pulled further beyond the container bottom. The container is hung up upside down by the hang tab.

Such hanger labels are known from the references DE 39 07 862 A1, DE 91 01 464 U1, EP 0 356 574 A2, and EP 0 632 422 A1, among others.

Hanging containers up upright by means of suitable film elements is also known, for example from the utility model reference DE 92 02 956 U1.

Sometimes, parting lines are also provided for other reasons. In DE 103 07 250 A1, a film element is described that has a parting line in order to uncouple regions of the film element under tensile stress, and thereby to reduce the risk of tearing of the stressed film element. A parting line terminates further tear spread in the case of tear formation crosswise to the expanse of the parting line. A parting line that reduces the risk of tearing in this manner can also be provided in the hang tab of a hanger label described above, for example.

However, parting lines can also lead to problems, particularly in the dispensing of labels. Since different tensile conditions prevail in the label parts that are uncoupled from one another along the parting line, undesirable displacements or folds can occur in the hang tab and/or in the remainder of the label. This can cause difficulties to occur in automated packaging or in use. Furthermore, fold formation can bring about the impression of inferior quality for the end consumer, so that such defective labeling is generally viewed as being production seconds.

In the case of safety parting lines (for the avoidance of tears), one attempts to counter this set of problems by means of an additional film layer that covers the parting line. However, this significantly increases the expenditure of materials and production, and thereby necessarily makes the end product more expensive.

In the case of hanger labels, there is furthermore the possibility of interrupting the parting line by means of small contact points, i.e. non-punched or non-slit segments, which limit the mobility of the hang tab relative to the remainder of the label and thereby reduce the risk of the formation of distortions. When the hang tab is pulled out, however, small areas of damage occur at its edge in this way, and these can be the starting points for tear formation and thereby greatly reduce the tear resistance of the hang tab.

With this background, it is the task of the present invention to create a film element having a parting line, in which the risk of the formation of distortions due to different stresses on the two sides of the parting line is reduced, but at the same time to avoid the disadvantages of conventional counter-measures indicated in detail above.

This task is accomplished, according to one aspect of the present invention, by means of a film element according to claim 1.

Advantageous embodiments of the film element according to the invention can be configured according to one of claims 2-19.

According to another aspect of the present invention, this task is accomplished by means of a method for producing a film element according to claim 20.

Advantageous embodiments of the method according to the invention can be configured according to one of claims 21-25.

According to the invention, a parting line is bridged by means of a mass that is printed on, sprayed on, cast on, or otherwise applied in a flowable state, and limits the mobility of the parts adjacent to one another at the parting line, relative to one another, after solidification by means of a drying and/or cross-linking and/or other physical and/or chemical process. Even film elements having only one film layer can be modified in simple and cost-advantageous manner in this way, causing them to be significantly more easily dispensable, particularly on automated or semi-automated dispensing machines. The bridging can advantageously take place on the top side, but bridging applied on the underside or elsewhere is also possible. Thus, in the case of a self-adhesive embodiment, the bridging layer can also be provided between a film layer and the underside adhesive coating, for example.

In addition to bridging the parting line, the bridging layer can combine additional functions in itself, for example increasing the stability and/or improving the haptic properties of a part of the film element. For example, hang tabs of hanger labels according to the invention that have been bridged over a flat area can be more easily grasped because of the reinforcing effect of the bridging.

The method according to the invention can be particularly used also for the production of hanger labels configured similar to those according to the state of the art. While the properties of the finished product are clearly improved according to the invention, conventional films or film composites in usual thickness ranges of 23-165 μm, preferably 86-165 μm, of PE, PP, PBT, or PET can continue to serve as starting materials, among others.

Often, the method according to the invention can be implemented on conventional production lines, if necessary with slight modifications, without any or only with slight additional costs.

Equipment variants that are usual in the field of labeling technology, such as documentation sections, authenticity identifiers, safety punches, and the like can easily be used also for film elements according to the invention.

Fundamentally, any variant of the invention described or indicated within the scope of the present application can be particularly advantageous, depending on the economic and technical conditions in an individual case. Unless something is stated to the contrary, and to the extent that it is fundamentally technically possible, individual characteristics of the embodiments described can be interchanged or combined with one another.

In the following, examples of preferred embodiments of the present invention will be explained in greater detail, using the related drawings. In this connection, the drawings are purely schematic, and are not representations to scale. In particular, layer thicknesses of the film elements shown are represented in greatly exaggerated manner, for reasons of better illustration. Elements that correspond to one another in the individual figures are provided with the same reference symbol, to the extent that this makes sense.

FIG. 1a shows a film element according to the invention in a top view; it is configured as a self-adhesive stirrup label.

FIG. 1b shows a sectional view of the film element shown in FIG. 1a; in this connection, the sectional plane is indicated in FIG. 1a as a dot-dash line A-A′, and the viewing direction is indicated with arrows.

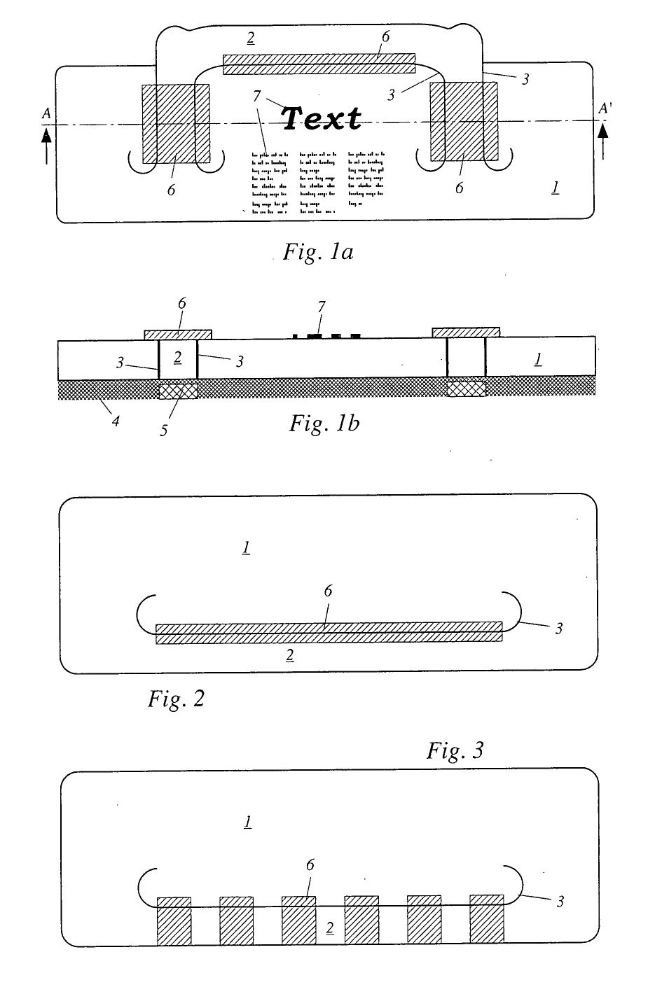

FIG. 2 shows a simpler embodiment of a film element according to the invention, also configured as a hanger label, in a top view.

FIG. 3 shows a film element according to the invention, also configured as a hanger label, in a top view, in which the bridging layer is interrupted several times and thus stretching of defined zones in the region of the hang tab is made possible.

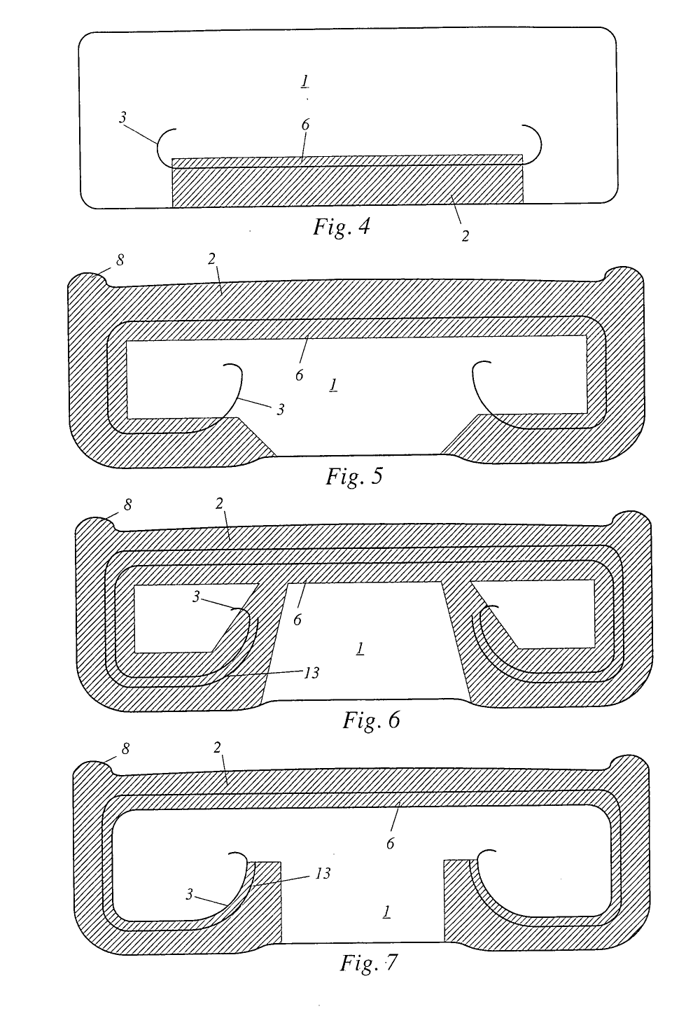

FIG. 4 shows another film element according to the invention, configured as a hanger label, in a top view, in which the bridging layer reaches up to the edge of the hang tab and thereby allows easier grasping of the hang tab by means of reinforcing it.

FIG. 5 shows another film element according to the invention, configured as a hanger label, in a top view, in which the bridging layer extends over a major portion of the hang tab and thereby reinforces it.

FIG. 6 shows a film element according to the invention, configured similar to that in FIG. 5, in which another parting line is provided in the hang tab as an additional security against tearing.

FIG. 7 shows a film element according to the invention, configured similar to that in FIG. 6, in which the bridging layer bridges the parting line that is provided in the hang tab as security against tearing, but not the parting line by means of which the hang tab is divided off from the remainder of the label.

The film element shown in FIGS. 1a and 1b, according to the invention, configured as a hanger label, has a base layer 1 of a plastic film, out of which the hang tab 2 can be pulled. For this purpose, the hang tab 2 is divided off from the remainder of the base layer 1 by means of punched parting lines 3, and the underside adhesive coating 4 is treated with a so-called adhesive killer in the region of the hang tab 2, so that here, a non-adhesive or weakly adhesive zone 5 occurs, while the remainder of the base layer 1 can firmly adhere to a container, as intended, by way of the adhesive coating 4. In place of the use of an adhesive killer, other known measures can also be used to make the hang tab 2 entirely or predominantly non-adhesive or weakly adhesive on the underside. For example, the adhesive coating 4 can be eliminated, bridged, or otherwise covered in the corresponding region.

The mobility of the hang tab 2 is limited with regard to the remainder of the base layer 1, by means of the bridging layer 6, which is imprinted onto the base layer 1 by means of preferably double screen printing after the parting lines 3 have been punched, preferably over the latter, in order to guarantee better dispensability. With a thickness of 3 μm up to several ten micrometers, the hang tab nevertheless can be pulled out of the remainder of the base layer 1, without problems, without the use of aids.

In order to be able to serve not only the hanging function but also for characterizing the contents of the container onto which the film element is glued, according to its intended use, it is provided with a text imprint 7.

FIG. 2 shows a simply configured form of a hanger label in which an imprinted bridging layer 6 also bridges the parting line 3 by means of which the hang tab 2 is defined.

FIG. 3 shows a hanger label configured similar to that in FIG. 2, but the bridging layer 6 is interrupted several times crosswise to the longest expanse of the hang tab 2, and reaches all the way to the edge of the hang tab 2 that lies opposite the parting line 3. This configuration makes it possible to lengthen the hang tab 2 in defined manner by means of stretching, at those locations where the bridging layer 6 is interrupted.

Stretching can preferably take place before or during, but also after application of the film element. The hang tab 2 domes up as a result and therefore is easier to grasp. Furthermore, defined lengthening of the hang tab 2 allows affixing the film element at a greater distance from the container bottom, without thereby causing problems when the hang tab 2 is pulled over the bottom edge of the container. Thus the demands with regard to precision of the positioning of the film element on the container are lowered, for one thing, and for another thing, a certain distance between container bottom and film element can be provided intentionally, something that is desirable for esthetic reasons, among others. In total, the ability to put the hang tab 2 over the container bottom is greatly improved by lengthening it.

In the case of the hanger label shown in FIG. 4, the bridging layer 6 also reaches all the way to the edge of the hang tab 2 that lies opposite the parting line 3. As a result, the hang tab 2 is reinforced and is given greater tear resistance, for one thing, and for another thing, it is given more pleasant haptic properties.

The film element shown in FIG. 5 is structured as a hanger label having a particularly long hang tab 2, which has two tab-like extensions 8 by means of which it can be more easily grasped. Since the bridging layer 6 that bridges the parting line 3 extends all the way into the tab-like extensions 8, these are relatively rigid and therefore easy to grasp. Furthermore, the bridging layer 6 covers almost the entire hang tab 2, thereby giving it greater stability against tearing. Because of the great length of the parting line 3, its bridging is particularly noticeable, in a positive way, as compared with conventional labels having the same cut size.

The label shown in FIG. 6, which is otherwise configured in similar manner to that shown in FIG. 5, is given additional security against tearing by means of an additional punching or slitting 13 in the hang tab 2. This additional parting line 13 runs approximately parallel to the parting line 3 and counteracts tear continuation or tear formation, respectively. Such additional parting lines 13 can be viewed as force distribution elements that are able to pass forces into undamaged material regions, along the weakening, i.e. to distribute them over a larger force-absorbing surface area. Thus, the stress maximum that occurs locally is reduced. In the case of tear formation, the tear merely spreads to the additional parting line 13, along which stress peaks are reduced, thereby reducing the stress on individual material segments. As a result, the force expenditure required for tear propagation is increased, and the tensile strength of the film element is increased in the region of the hang tab 2. Furthermore, the additional parting line 13 acts as a clearly defined tear stop, i.e. as a pre-determined tear end, if a tear should begin to spread from the edge of the grasping tab 2.

The film element shown in FIG. 7 is configured similar to that in FIG. 6, but here, the bridging layer 6 only bridges the additional parting line 13, but not the parting line 3 that defines the hang tab.

Even though the bridging layer 6 is structured only over part of the area in all of the figures, according to the invention, the base layer 1 can also be coated with the bridging layer 6 over its entire area.

Fundamentally, the bridging layer 6 can consist of the most varied materials, for example, in addition to usual printing ink, also Braille ink or other conventional relief inks, as well as the most varied previously known printable masses. Flexible, thinly applied casting resins, for example of polyurethane, can also be advantageous; they bring about particularly great stability and particularly pleasant haptic properties. An embodiment of the bridging layer 6 as an extrusion coating, for example of PE or PP, is also particularly advantageous.

In the case of multi-layer film structures, the bridging layer 6 can also be disposed between two film layers.

In the following, an advantageous production sequence will be briefly described, as an example; using this process, film elements according to the invention can be produced from starting material presented in web form, on a large technical scale.

A plastic film web intended for the formation of the base layer 1 runs in, in an adhesive composite, with a support of pull-off material. Depending on the intended use, the plastic film web can be transparent or opaque. The adhesive composite is delaminated, whereupon imprinting of an adhesive killer to produce non-adhesive zones 5 as well as imprinting of a control mark for optically supported control of the subsequent production steps, if necessary, can take place. Alternatively, the imprinting of the control mark can also take place before delamination. After renewed lamination of the plastic film web with the support, imprinting with colored inks can take place. Subsequently, the parting line 3 is punched, which is at least partially bridged with the bridging layer 6. Afterwards, further punching can take place. For example, it is a particularly good possibility to punch the outside contour of the film element after imprinting of the bridging layer 6, if the latter is to reach all the way to the edge of the film element, as shown in FIGS. 3-7. If, on the other hand, the bridging layer 6 is imprinted after the outside contour is punched, the bridging layer 6 can sometimes have a disruptive effect during the final removal of the label surround.

Instead of a film composite, the plastic film can also run in without a support and be provided with the adhesive layer 4 in-line, if necessary.

Another advantageous variant provides that the bridging layer 6 is imprinted together with the adhesive killer, or that the adhesive killer itself forms the bridging layer 6. This means that the adhesive layer is over-printed under the region of the hang tab 2 (over the full area or a partial area), as well as going slightly beyond it, and thus bridging the parting line 3. In this way, production can be made even more inexpensive, as compared with separate printing of the bridging layer 6.

1. Film element, having a parting line (3) that is bridged at least partially with at least one bridging layer (6), which consists of a mass applied in the flowable state and subsequently solidified.

2. Film element according to claim 1, wherein the bridging layer (6) extends only over a part of the area of the film element.

3. Film element according to claim 1, wherein the mass is printed on, sprayed on, or cast on.

4. Film element according to claim 3, wherein the mass consists at least partially of printing ink, varnish, extruded polymer mass, or polyurethane casting mass.

5. Film element according to claim 1, wherein the bridging layer (6) has a thickness of at least 3 micrometers.

6. Film element according to claim 5, wherein the bridging layer (6) has a thickness of at least 10 micrometers.

7. Film element according to claim 6, wherein the bridging layer (6) has a thickness of at least 20 micrometers.

8. Film element according to claim 7, wherein the bridging layer (6) has a thickness of at least 50 micrometers.

9. Film element according to claim 1, wherein the bridging layer (6) has a thickness of at most 2 millimeters.

10. Film element according to claim 9, wherein the bridging layer (6) has a thickness of at most 100 micrometers.

11. Film element according to claim 1, wherein the parting line (3) is a punched line or slit.

12. Film element according to claim 11, wherein the film element has a hang tab (2) that is defined by the parting line (3).

13. Film element according to claim 12, wherein the bridging layer (6) covers at least the predominant part of the hang tab (2).

14. Film element according to claim 12, wherein the film element has an additional parting line (13) in the region of the hang tab (2), which is at least partially bridged by the bridging layer (6).

15. Film element according to claim 1 wherein the film element is at least partially non-adhesive or weakly adhesive in the region of the hang tab (2), on the underside.

16. Film element according to claim 15, wherein the film element is at least predominantly non-adhesive or weakly adhesive in the region of the hang tab (2), on the underside.

17. Film element according to claim 1, which is configured to be self-adhesive at least over part of the area, on the underside.

18. Film element according to claim 1, which possesses only one plastic film layer (1).

19. Film element according to claim 1, which is provided with text information and/or character information and/or code information (7).

20. Method for the production of a film, wherein
a film (1) or a film composite is presented,
at least one parting line (3) is made in the film (1) or the film composite,
and
the parting line (3) is bridged at least partially by means of the application of a mass applied in the flowable state, which solidifies after application and forms a bridging layer (6).

21. Method according to claim 20, wherein the mass is printed on, sprayed on, or cast on.

22. Method according to claim 20, wherein the parting line (3) is slit or punched.

23. Method according to claim 2 wherein the film (1) or the film composite is presented in web form.

24. Method according to claim 23, wherein the film element is punched out of the web after application of the mass (6), in such a manner that the punching takes place through the bridging layer (6), so that the bridging layer (6) reaches all the way to the edge of the film element.

25. Method according to claim 23, wherein the method is carried out continuously or quasi-continuously in a process that is at least partially automated.
